(19) United States
(12) Patent Application Publication
(10) Pub. No.: US 2025/0357571 A1
(43) Pub. Date: Nov. 20, 2025

(54) TRAY FOR ACCOMMODATING A PART CAPABLE OF GIVING OFF HEAT

(71) Applicant: VALEO SYSTEMES THERMIQUES, Le Mesnil-Saint-Denis (FR)

(72) Inventor: Jean-Louis Lanard, Le Mesnil-Saint-Denis (FR)

(73) Assignee: VALEO SYSTEMES THERMIQUES, Le Mesnil-Saint-Denis (FR)

(21) Appl. No.: 18/872,025

(22) PCT Filed: May 31, 2023
(86) PCT No.: PCT/EP2023/064484

§ 371 Date: Dec. 5, 2024

(30) Foreign Application Priority Data
Jun. 8, 2022 (FR) FR2205472

(51) Int. Cl. H01M 10/6556; B21D 5/16; H01M 10/613; H01M 10/625; H01M 10/6554; H01M 10/6569; H01M 10/663; H01M 50/249

(52) U.S. Cl. CPC H01M 10/6556; B21D 5/16; H01M 10/613; H01M 10/625; H01M 10/6554; H01M 10/6569; H01M 10/663; H01M 50/249; H01M 2220/20

(57) ABSTRACT

A tray is configured to accommodate a part capable of giving off heat during its operation. The part may be an electrochemical energy storage module. The tray includes a bottom wall configured to accommodate the part and at least one side wall attached to the bottom wall. The at least one lateral wall includes an internal plate and an external plate that are assembled together to form at least one heat transfer fluid flow channel. The side wall includes a periphery provided with at least one folded corner.

The present invention relates to a tray, arranged to receive a component capable of giving off heat during its operation. The invention also relates to a method for manufacturing such a tray.

The invention relates in particular to a tray for cooling at least one electrochemical storage module, in particular for the automotive field.

Electrochemical storage modules, namely battery modules intended for electric or hybrid vehicles, have to, as far as possible, be kept at the desired temperature for optimal operation. To this end, temperature regulation devices are used, either to cool or to heat said modules so as to keep them at a desired temperature. In particular, the temperature regulation devices have a tray arranged to receive the battery modules.

The invention aims to simplify the design and manufacture of the compartment so as to thus reduce the manufacturing cost.

The invention thus proposes a tray arranged to receive a component capable of giving off heat during its operation, this component in particular being an electrochemical energy storage module, the tray comprising:
a bottom wall arranged to receive the component;
at least one lateral wall fastened to the bottom wall and comprising, in particular, an internal plate and an external plate that are assembled together so as to form at least one heat-transfer fluid circulation channel, this lateral wall having a perimeter provided with at least one folded corner.

By virtue of the invention, the lateral wall may be continuous over the one or more corners of its perimeter, unlike a lateral wall that would be formed by a plurality of panels assembled at the corners. The invention thus offers better sealing because at least some corners of the perimeter are not formed by join lines that could have a sealing defect.

In addition, the invention makes it possible, in order to manufacture the lateral wall, to use fewer elements to be assembled, and this may reduce the manufacturing cost of the tray.

According to one of the aspects of the invention, the folded corner is substantially rounded.

According to one of the aspects of the invention, the lateral wall has a height measured in a direction perpendicular to the bottom wall, and the folded corner extends over all of this height of the lateral wall.

According to one of the aspects of the invention, the lateral wall has a closed perimeter and comprises a joining line along which the lateral wall is closed on itself.

According to one of the aspects of the invention, the joining line is rectilinear and extends over the entire height of the lateral wall.

According to one of the aspects of the invention, the joining line is a weld line that connects two contiguous edges of the lateral wall.

According to one of the aspects of the invention, the perimeter of the lateral wall is substantially rectangular with three rounded folded corners, and one corner formed by the joining line.

According to one of the aspects of the invention, the lateral wall has an extension defining an internal wall, inside the perimeter of the lateral wall.

According to one of the aspects of the invention, the internal wall extends between two locations for components to be cooled. Thus, the one or more channels in this internal wall serve to cool the components on either side of the internal wall.

According to one of the aspects of the invention, the internal wall is substantially flat, in particular extending between two opposite edges of the perimeter of the lateral wall.

According to one of the aspects of the invention, the lateral wall has two extensions defining two internal walls that adjoin one another, inside the perimeter of the lateral wall.

According to one of the aspects of the invention, the assembled plates of the lateral wall are made of metal, in particular of aluminum.

According to one of the aspects of the invention, the internal and external plates of the lateral wall are assembled together by welding, brazing or adhesive bonding.

According to one of the aspects of the invention, the internal plate faces the inside of the tray, and the external plate faces the outside of the tray.

According to one of the aspects of the invention, the external plate has a plurality of recessed areas forming the one or more heat-transfer fluid circulation channels.

According to one of the aspects of the invention, the external plate has flat junction areas, in particular between the recessed areas, these flat junction areas being arranged to be pressed against the internal plate so as to form the one or more heat-transfer fluid circulation channels.

According to one of the aspects of the invention, the folded corner of the lateral wall corresponds to folded corners of the internal and external plates.

According to one of the aspects of the invention, the bottom wall has at least two plates forming between one another one or more heat-transfer fluid circulation channels.

According to one of the aspects of the invention, the internal face of the bottom wall is flat. Thus, the contact surface between the component and the bottom wall is maximized such that the heat exchange between the bottom wall and the component is optimized.

According to one of the aspects of the invention, the bottom wall has an internal plate comprising an internal face on which the component can be laid and an external plate forming, with the internal plate, one or more heat-transfer fluid circulation channels.

According to one of the aspects of the invention, the lateral wall is welded or brazed to the bottom wall.

According to one of the aspects of the invention, the welding method is MIG (metal inert gas)-MAG (metal active gas) welding.

As a variant, the welding method is laser welding.

According to one of the aspects of the invention, the tray comprises a weld bead between the lateral wall and the bottom wall.

According to one of the aspects of the invention, the weld bead extends over the entire perimeter of the lateral wall, or a portion of this perimeter.

According to one of the aspects of the invention, the tray comprises a seal, in particular based on resin, which runs along a junction line between the lateral wall and the bottom wall.

According to one of the aspects of the invention, the lateral wall or the bottom wall comprises at least one fluid inlet or outlet orifice so as to allow external fluid supply or collection tubes to be connected to the channel or channels present in these walls.

According to one of the aspects of the invention, the lateral wall and/or the bottom wall comprises heat-transfer fluid circulation channels arranged to allow a counter-current flow (or counterflow), namely, the channels have at least two parallel neighboring sections with opposite directions of flow.

According to one of the aspects of the invention, the tray comprises a cover arranged to be fastened to the lateral wall.

The invention also relates to an assembly comprising at least one component, in particular at least one electrochemical energy storage module, and a tray as mentioned above, arranged to exchange heat with this component placed on the bottom wall of the tray.

Another subject of the invention is a method for producing a tray arranged to receive a component capable of giving off heat during its operation, this component in particular being an electrochemical energy storage module, the method comprising the following steps:
providing a bottom wall arranged to receive the component;
folding a double-plate structure, in particular made of metal, so as to form a lateral wall comprising an internal plate and an external plate that together form at least one heat-transfer fluid circulation channel, the fold corresponding to a corner of the perimeter of the lateral wall,
fastening the lateral wall to the bottom wall.

According to one of the aspects of the invention, the method involves the following step:
heating the double-plate structure prior to the folding step.

Deformation so as to fold the double-plate structure may be easier once heated.

According to one of the aspects of the invention, the double-plate structure is heated in a furnace.

According to one of the aspects of the invention, the double-plate structure is folded upon contact with a mandrel, in particular of cylindrical shape, so as to form the one or more rounded corners.

According to one of the aspects of the invention, the double-plate structure is wound around a mandrel and stretched at the same time in order to limit the crushing of the channels.

According to one of the aspects of the invention, the double-plate structure is folded at a plurality of locations in order to form an extension defining an internal wall, inside the perimeter of the lateral wall. For example, the double-plate structure is folded at at least 5 locations, forming at least 5 rounded corners.

According to one of the aspects of the invention, the heat-transfer fluid is a refrigerant fluid, in particular a fluid selected from the refrigerant fluids R134a, R1234yf and R744, or a glycol water.

According to one of the aspects of the invention, the heat-transfer fluid is itself cooled by an evaporation exchanger (referred to as a chiller) connected to an air conditioning loop of the vehicle.

According to one of the aspects of the invention, the component is an electrochemical energy storage module that is selected from battery modules of the Li-ion, Li-air, Lithium polymer, Lithium sulfur, Lithium metal, Na-ion, Na-air, K-ion, Mg-ion, or Zn-air type.

According to one of the aspects of the invention, the component is a fuel cell.

The component may be an electrochemical energy storage module, in particular a battery module, comprising one or more battery cells, which are in particular housed in a housing. The tray may receive one or more modules. The modules may be disposed in the tray in one row or in a plurality of parallel rows.

Further features and advantages of the invention will become more clearly apparent upon reading the following description, which is given by way of illustrative and non-limiting example, and the appended drawings, in which:

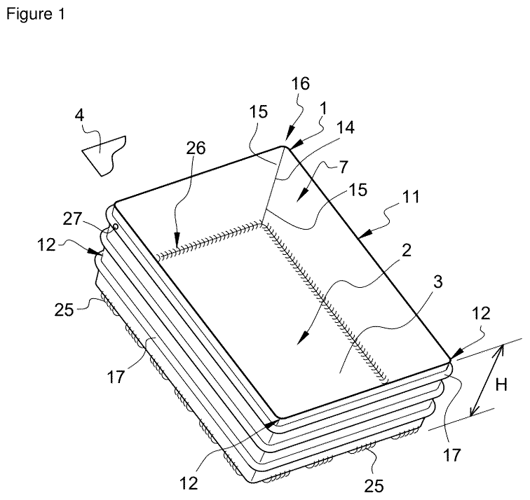

FIG. 1 schematically and partially illustrates a perspective view of a tray according to one implementation example of the invention;

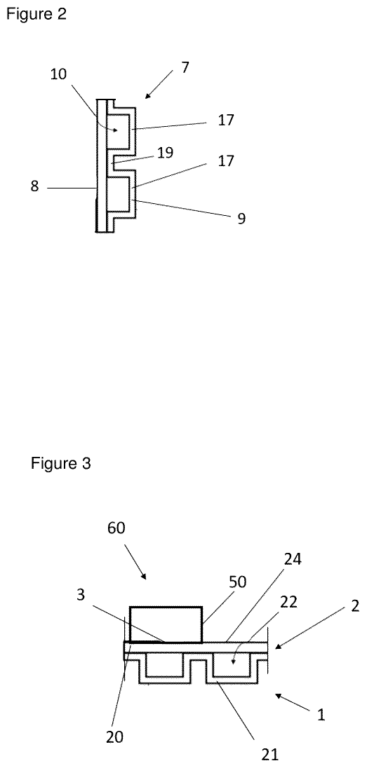

FIG. 2 schematically illustrates a view in cross section of the tray in [FIG. 1];

FIG. 3 schematically illustrates a view in cross section of the bottom wall of the tray in [FIG. 1];

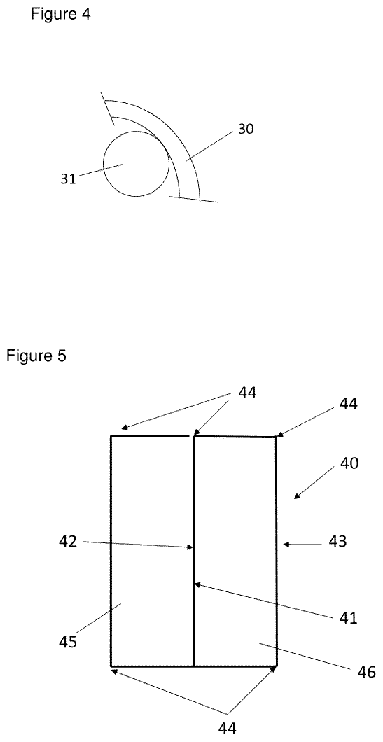

FIG. 4 schematically illustrates a mandrel upon contact with which the lateral wall is folded,

FIG. 5 schematically and partially illustrates a view from above of a module according to another implementation example of the invention.

Below, in the drawings, the same numerical references denote the same elements or members.

FIG. 1 shows a perspective view of a tray 1 arranged to receive components 50 placed on a flat internal face 3 of a bottom wall 2 of the tray 1.

The tray 1 further comprises a cover 4 arranged to be fastened to a lateral wall 7 of the tray 1.

Each component 50 is an electrochemical energy storage module.

The electrochemical energy storage module is selected from battery modules of the Li-ion, Li-air, Lithium polymer, Lithium sulfur, Lithium metal, Na-ion, Na-air, K-ion, Mg-ion, or Zn-air type.

In the example described, the tray 1 receives two rows with six modules each, such that a total of twelve modules are housed in this tray 1. Each module may be fastened in the tray 1 by means of fastening elements such as screws (not shown). Each module has a rectangular perimeter.

The lateral wall 7 is fastened to the bottom wall 2 and comprises, as illustrated in FIG. 2, an internal plate 8 and an external plate 9 that are assembled together so as to form heat-transfer fluid circulation channels 10.

The internal plate 8 faces the inside of the tray 1, and the external plate 9 faces the outside of the tray 1.

This lateral wall 7 has a perimeter 11 provided with three folded corners 12.

Each folded corner 12 is substantially rounded.

The lateral wall 7 has a height H measured in a direction perpendicular to the bottom wall, and the folded corners extend over all of this height H of the lateral wall 7.

The perimeter 11 is closed and comprises a joining line 14 along which the lateral wall 7 is closed on itself.

The joining line 14 is rectilinear and extends over the entire height H of the lateral wall 7. This joining line 14 is a weld line that connects two contiguous edges 15 of the lateral wall 7.

Thus, the perimeter 11 of the lateral wall 7 is substantially rectangular with three rounded folded corners 12, and one corner 16 formed by the joining line 14.

The assembled plates 8 and 9 of the lateral wall 7 are made of metal, in this case of aluminum. The assembling is done by welding, brazing or adhesive bonding.

The external plate 9 has a plurality of recessed areas 17 forming the heat-transfer fluid circulation channels 10.

The external plate 9 has flat junction areas 19, between the recessed areas 17, these flat junction areas 19 being arranged to be pressed against the internal plate 8 so as to form the heat-transfer fluid circulation channels 10.

Each folded corner 12 of the lateral wall 7 corresponds to folded corners of the internal and external plates 8 and 9.

Similarly, as illustrated in FIG. 3, the bottom wall 3 has two plates 20 and 21 forming between one another a plurality of heat-transfer fluid circulation channels 22.

The internal face of the bottom wall 2 is flat. Thus, the contact surface between the components 50 and the bottom wall 2 is maximized such that the heat exchange between the bottom wall 2 and the components 50 is optimized.

Thus, the internal plate 20 comprises an internal face 24 on which the components 50 are laid and the external plate 21 forms, with the internal plate 20, the heat-transfer fluid circulation channels 22.

The lateral wall 7 is welded to the bottom wall 2 by MIG (metal inert gas) welding.

Thus, the tray 1 comprises weld beads 25 between the lateral wall 7 and the bottom wall 2. These weld beads 25 extend discontinuously over the entire perimeter of the lateral wall 7, at its base.

The tray 1 further comprises a seal 26, based on resin such as mastic, which runs along a junction line between the lateral wall 7 and the bottom wall 2, inside the tray 1.

The lateral wall 7 comprises fluid inlet or outlet orifices 27, only one of which is shown in FIG. 1, so as to allow external fluid supply or collection tubes to be connected to the channels 10 present in this lateral wall 7.

An assembly 60 is thus formed comprising the electrochemical energy storage modules 50, and the tray 1 arranged to exchange heat with these modules 50 placed on the bottom wall 2.

The method for manufacturing the tray 1 comprises the following steps:
providing the bottom wall 2;
folding a double-plate structure 30 (visible in FIG. 4) so as to form the lateral wall 7, each fold corresponding to a corner 12 of the perimeter of the lateral wall 7,
fastening the lateral wall 7 thus formed to the bottom wall 2.

The double-plate structure 30 is heated, for example in a furnace, prior to the folding step.

The double-plate structure 30 is folded upon contact with a mandrel 31, of cylindrical shape, so as to form the rounded corners 12. Preferably, the double-plate structure 30 is wound around the mandrel 31 and stretched at the same time in order to limit the crushing of the channels 10.

The heat-transfer fluid is a refrigerant fluid, in particular a fluid selected from the refrigerant fluids R134a, R1234yf and R744, or a glycol water.

The heat-transfer fluid is itself cooled by an evaporation exchanger (referred to as a chiller) connected to an air conditioning loop of the vehicle.

FIG. 5 illustrates another implementation example of the invention.

In this example, the double-plate structure 40 is folded so as to form an extension 41 defining an internal wall 42, inside the perimeter of the lateral wall 43. The double-plate structure 40 is folded at 5 locations, forming 5 rounded corners 44.

The internal wall 42 is substantially centered so as to divide the inside of the tray into two volumes 45 and 46. As a variant, this internal wall 42 may be placed differently, for example in an off-center manner.

1. A tray arranged to receive a component capable of giving off heat during its operation, wherein the component is an electrochemical energy storage module, the tray comprising:
a bottom wall arranged to receive the component; and
at least one lateral wall fastened to the bottom wall and comprising:
an internal plate; and
an external plate that are assembled together so as to form at least one heat-transfer fluid circulation channel,
wherein the lateral wall having a perimeter provided with at least one folded corner.

2. The tray as claimed in claim 1, wherein the folded corner is substantially rounded.

3. The tray as claimed in claim 1, wherein the lateral wall has a height measured in a direction perpendicular to the bottom wall, and the folded corner extends over all of this height of the lateral wall.

4. The tray as claimed in claim 1, wherein the lateral wall has a closed perimeter and comprises a joining line along which the lateral wall is closed on itself.

5. The tray as claimed in claim 1, wherein the lateral wall has an extension defining an internal wall, inside the perimeter of the lateral wall.

6. The tray as claimed in claim 1, wherein the assembled plates of the lateral wall are made of metal.

7. The tray as claimed in claim 1, wherein the bottom wall has at least two plates forming between one another one or more heat-transfer fluid circulation channels.

8. The tray as claimed in claim 1, wherein the tray comprises a weld bead between the lateral wall and the bottom wall.

9. The tray as claimed in claim 1, wherein the tray comprises a seal which runs along a junction line between the lateral wall and the bottom wall.

10. An assembly comprising:
at least one component,
wherein the at least one component includes at least one electrochemical energy storage module; and
a tray as claimed in claim 1, arranged to exchange heat with this component placed on the bottom wall of the tray.

11. A method for producing a tray arranged to receive a component capable of giving off heat during its operation, wherein the component is an electrochemical energy storage module, the method comprising the following steps:
providing a bottom wall arranged to receive the component;
folding a double-plate structure so as to form a lateral wall comprising an internal plate and an external plate that together form at least one heat-transfer fluid circulation channel, the fold corresponding to a corner of a perimeter of the lateral wall; and
fastening the lateral wall to the bottom wall.

12. The method as claimed in claim 11, involving the following step:
heating the double-plate structure prior to the folding step.

13. The method as claimed in claim 11, wherein the double-plate structure is folded upon contact with a mandrel so as to form one or more rounded corners.
